(19) United States
(12) Patent Application Publication
(10) Pub. No.: US 2026/0342274 A1
(43) Pub. Date: Oct. 29, 2026

(54) SOLAR TRACKING SYSTEM WITH REVERSIBLE TRACKER DRIVE ASSEMBLY

(71) Applicant: ARRAY TECH, INC., Albuquerque, NM (US)

(72) Inventor: Thierry Marin-Martinod, Chandler, AZ (US)

(21) Appl. No.: 19/535,285

(22) Filed: Feb. 10, 2026

Related U.S. Application Data
(60) Provisional application No. 63/758,973, filed on Feb. 14, 2025.
(60) Provisional application No. 63/775,089, filed on Mar. 20, 2025.

(51) Int. Cl. H02S 20/32; H02P 3/12

(52) U.S. Cl. CPC H02S 20/32; H02P 3/12

(57) ABSTRACT

A system for controlling rotation of torque tube in a solar energy system is provided. In one form, the system includes an electric motor, a back-drivable gear assembly configured for coupling the electric motor to the torque tube, and a control module configured to control various operational aspects of the electric motor.

### CROSS-REFERENCE TO RELATED APPLICATIONS

This patent application claims priority to and the benefit of United States Provisional Patent Application Ser. No. 63/758,973, filed Feb. 14, 2025, and United States Provisional Patent Application Ser. No. 63/775,089, filed Mar. 20, 2025, which are incorporated by reference in their entireties.

### TECHNICAL FIELD

The present disclosure relates to solar tracking systems that include reversible tracker drive assemblies.

### BACKGROUND

Solar farms, photovoltaic (PV) plants, and other solar tracking systems where large numbers of PV modules collect sunlight and generate energy are becoming more common. In some of these systems, multiple PV modules are coupled to a single torque tube, which is mounted on one or more support structures, or piles. Torque tube interfaces may be used to secure a torque tube to the support structures. In solar panel tracking systems (or systems in which the PV modules are able to track the location of the Sun throughout the day), the torque tube is coupled to the torque tube interface in a way that permits the torque tube to rotate relative to the support structure. A tracker drive may be used to selectively rotate the torque tube and PV modules coupled thereto. Changing the angle of a PV module with respect to a support structure enables the PV module to track the location of the Sun and maximize efficiency.

While rotating a torque tube to change an angle of PV modules enables the PV modules to track the location of the Sun and increase the efficiency of the system, this rotational freedom can also create undesirable effects. For example, wind, seismic events, snow accumulation, and other forces on the PV modules can damage the PV modules. These forces may also create a rotational torque on the torque tube, which may be translated back through and damage components of the tracker drive assembly.

In order to protect PV modules and tracker drive components from damage, some tracker drive assemblies include mechanical clutch mechanisms that allow slippage to occur between components when a rotational torque exceeds a threshold. Once a slippage occurs, PV panels may move into a stow position. Examples of these mechanical clutch mechanisms include U.S. Pat. No. 11,988,260 and U.S. Pat. No. 9,581,678, the disclosures of which are incorporated herein by reference. Mechanical dampers may also be installed to control a rate at which the PV panels move after a clutch mechanism has slipped.

Existing mechanical clutch and damper mechanisms, however, may result in a reduction in the efficiency of the solar tracking system because after a slippage by a clutch, the PV modules may no longer be properly tracking the location of the Sun. In some systems, a realignment of the PV modules with the location of the Sun may not occur until the PV modules are reset at the beginning of a new day. Depending on when during the day the clutch slipped and how many PV modules were affected by the slippage, a significant amount of efficiency may be lost while waiting for the PV modules to be reset to a proper tracking position.

Accordingly, there is a need for additional contributions in this area of technology. The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in conventional solar panel tracking systems, including problems associated with wind or other forces applied to PV modules or other system components that cause rotation of a torque tube and may result in damage or destruction of PV modules and other tracker components. In one embodiment, a system includes a reversible tracker drive assembly which includes an electric motor and a back-drivable gear assembly. The system also includes a control module that is configured to control various operational aspects of the electric motor. The back-drivable gear assembly is configured to provide an output from the motor to the torque tube for rotating the torque tube in a desired manner such as to facilitate tracking the location of the Sun with the PV modules. The back-drivable gear assembly is also configured to provide a back force to the motor when an external force, such as wind, is applied to PV modules and/or other tracker components in a manner that creates a rotation force on the torque tube which in turn is translated to the back-drivable gear assembly.

The control module is configured to operate the motor at various different power levels as necessary to counteract the incoming force caused by wind while maintaining desired rotation of the torque tube for tracking the location of the Sun with the PV modules. However, if the force of the wind or other event becomes too high, then the back force at the electric motor may exceed a threshold power level of the electric motor such that the electric motor can no longer counteract the back force. As a result, the torque tube may begin to rotate due to the back force. When this occurs, the control module is configured to control the rotation rate of the torque tube by controlling an amount of resistance provided by the electric motor and provide a braking torque on the torque tube. Effectively, the electric motor becomes a generator, which may convert the rotational kinetic energy from the back force into electrical energy. This electrical energy may then be dissipated in the form of heat through a resistor network or used to load a battery or a capacitor.

The amount of resistance provided by the electric motor may be variable such that the rotation rate of the torque tube may change depending on the orientation of the PV modules. For example, the rotation rate of the torque tube may be controlled to be slower near a stow position of the PV modules to avoid damage to the PV modules and other components as the PV modules near a mechanical end stop corresponding to the stow position.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the accompanying drawings in which:

FIG. 1 is an illustration of a solar tracking system that includes a reversible tracker drive assembly;

FIG. 2 is a perspective illustration of a portion of the solar tracking system illustrated in FIG. 1 with PV modules omitted;

FIG. 3 is a schematic illustration of a system that includes the reversible tracker drive assembly and is configured to control or regulate rotation of a torque tube of the system illustrated in FIG. 1;

FIG. 4 is an illustration of an alternative embodiment solar tracking system that includes a plurality of reversible tracker drive assemblies;

FIG. 5 is a schematic illustration of an alternative system that includes the plurality of reversible tracker drive assemblies and is configured to control or regulate rotation of a torque tube of the system illustrated in FIG. 4;

FIG. 6 is a schematic illustration of another alternative system for controlling rotation of a torque tube in a solar tracking system; and

FIG. 7 schematically illustrates an example computing system.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

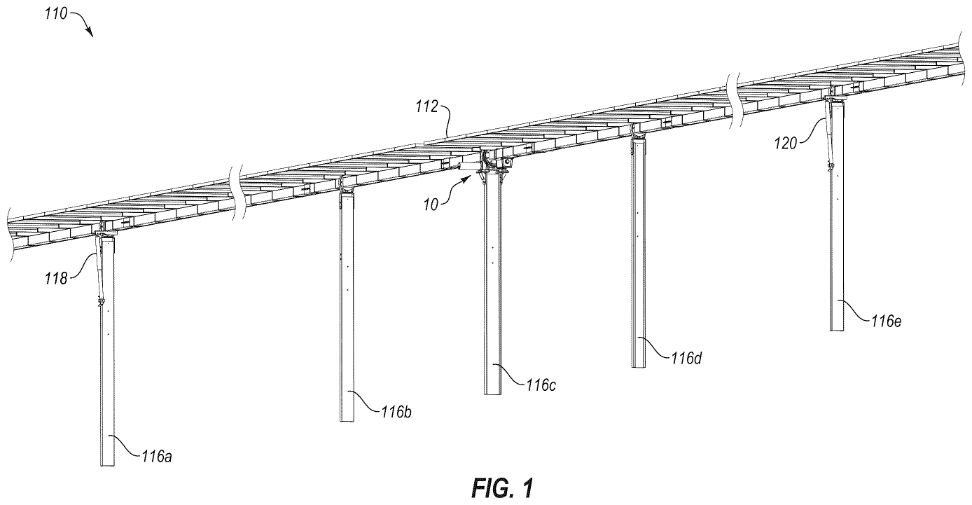

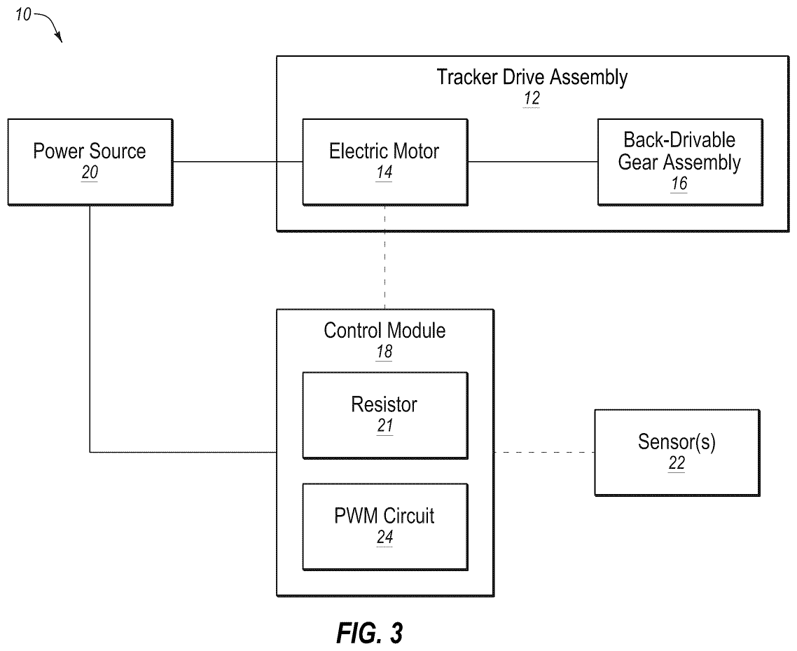

With general reference to FIGS. 1-3, there is illustrated a system 10 that controls or regulates rotation of a torque tube in a solar panel tracking system 110. The solar panel tracking system 110 includes a number of PV modules 112 coupled to a torque tube 114, and the torque tube 114 is further coupled to support structures 116a-e in a way that allows the torque tube 114, and the number of PV modules 112 coupled to the torque tube 114, to rotate relative to the support structures 116a-e. Rotation of the torque tube 114 results in movement of the PV modules 112 and may, for example, enable the PV modules 112 to track the location of the Sun throughout the day and increase the efficiency of the system 110.

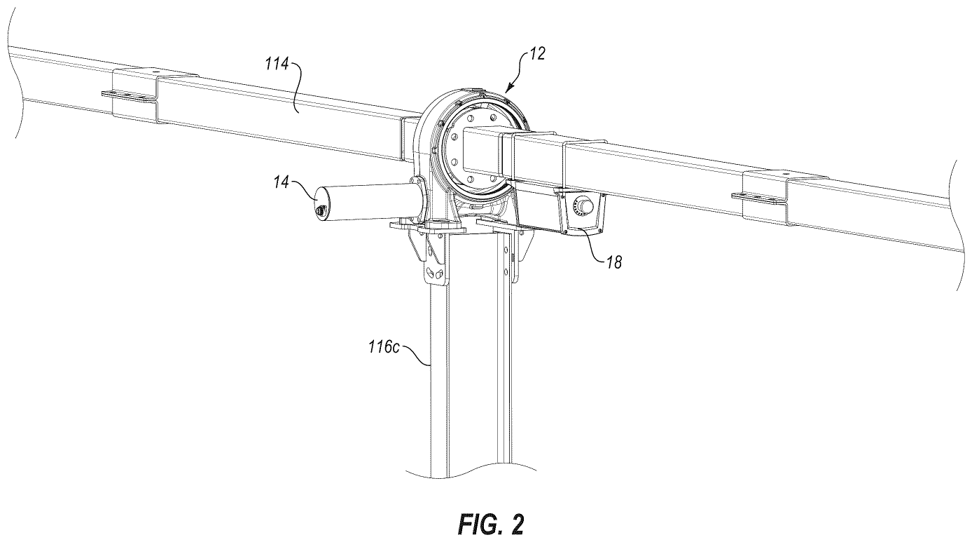

The system 10 includes a reversible tracker drive assembly 12 that includes an electric motor 14 and a back-drivable gear assembly 16. The system 10 also includes a control module 18 that is configured to control various operational aspects of the electric motor 14. As best seen in FIG. 2 for example, the reversible tracker drive assembly 12 is coupled to the torque tube 114 and the support structure 116c, and is configured to rotate the torque tube 114 relative to the support structures 116a-f. The system 10 also includes a power source 20 to provide power to the electric motor 14 and the control module 18. By way of non-limiting example, the power source may be a battery, a capacitor or a line from a power grid. The torque tube 114 is coupled to the electric motor 14 by the back-drivable gear assembly 16 to provide an arrangement where an output from the electric motor 14 may be translated by the back-drivable gear assembly 16 into a rotational force applied to the torque tube 114. In this arrangement, the electric motor 14 may rotate the torque tube 114 in a desired manner such as to facilitate tracking the location of the Sun with the PV modules 112 or to move the PV modules 112 to a stow position. The electric motor 14 may be a DC motor, an AC motor, a brushless DC motor or a permanent magnet motor, just to provide a few non-limiting examples.

The back-drivable gear assembly 16 is also structured to provide a back force to the electric motor 14 when an external force, which may be created by wind or snow accumulation on the PV modules 112 or seismic activity, etc., is applied to the PV modules 112 and/or other components of the system 110 in a manner that creates a rotation force on the torque tube 114. In one non-limiting form, the back-drivable gear assembly 16 includes a back-drivable high reduction gearbox (which may include planetary gears) coupled to the electric motor 14, and a back-drivable slew drive coupled with the back-drivable high reduction gearbox and the torque tube 114. In one form, the back-drivable slew drive may be oil-lubricated and include a low gear ratio. However, it should be appreciated that other variations in the back-drivable gear assembly 16 and the components thereof are possible and contemplated. Further, the gear reduction ratio of the back-drivable gear assembly 16 may be optimized with the size of the electric motor 14 (torque). In addition, the inertia of the back-drivable gear assembly 16 may be suitable for blocking the rotation of the torque tube 114 due to its inertia under wind gusts, and may likewise avoid a fluttering effect of the torque tube 114 and the PV modules 112 mounted thereon.

The control module 18 may be wired or wirelessly coupled to and communicative with the electric motor 14 and, as indicated above, is configured to control various operational aspects of the electric motor 14. For example, the control module 18 is configured to control operation of the electric motor 14 as necessary for rotation of the torque tube 114 to track the location of the Sun with the PV modules 112. In doing so, the control module 18 may control the output from the electric motor 14 by controlling the amount of power supplied to the electric motor 14, although other variations are contemplated. The output from the electric motor 14 required for providing sufficient torque for rotating the torque tube 114 may vary depending on the location/orientation of the PV 112 modules during the tracking cycle of the Sun (i.e., the tilt angle of the PV modules), the number, size and weight of the PV modules 112 coupled to the torque tube 114, and the length of the torque tube 114, amongst other things. The control module 18 may be programmed to account for these different variables in order to provide proper control of the electric motor 14 at a given time to maintain desired rotation of the torque tube 114 and tracking of the PV modules 112.

Further, the output from the electric motor 14 required for providing sufficient torque for rotating the torque tube 114 may increase when wind, for example, bears against the PV modules 112 and/or other components of the solar tracking system 110. In order to account for the effect of the wind, the system 10 may include a number of sensors 22 which may be wired or wirelessly coupled to and communicative with one or more components of the system 10, including for example the control module 18. The sensor(s) 22 may be configured to provide wind data such as direction and speed to the control module 18, and the control module 18 is configured to account for the wind data in addition to the other variables mentioned above in order to control the electric motor 14 in a manner that provides desired rotation of the torque tube 114. Additionally or alternatively, one or more of the sensors (22) may measure resistance to the output of the electric motor 14 and the control module 18 may be configured to increase the output from the electric motor 14 as necessary to overcome this resistance which may be a current (amperage). However, at some point the force of the wind (and/or other external force(s)) may reach a level that will result in damage to the PV modules 112 and/or other components of the solar tracking system 110 if rotation of the torque tube 114 in the desired direction continues and/or the PV modules 112 are not moved to a stow position.

In order to account for this possibility, the control module 18 is configured to limit the output from the electric motor 14 to a maximum threshold level that will allow back-driving of the electric motor 14 via the back-drivable gear assembly 16 when the force of the wind (and/or some other external force(s)) is sufficiently high, and in turn corresponding rotation of the torque tube 114, before there is damage to the PV modules 112 and/or other components of the solar tracking system 110. For example, rotation of the torque tube 114 in this manner may facilitate positioning of the PV modules 112 mounted on the torque tube 114 in a stow position. In some forms for example, if wind consistently creates a rotation force (torque) on the torque tube 114 which is above the maximum threshold level of the electric motor 14, then the torque tube 114 will rotate or “slip” to its stow position (corresponding to the stow position of the PV modules 112 mounted on the torque tube 114). The maximum threshold level of the output from the electric motor 14 may be selectively adjustable and may be dependent on the speed and/or direction of the wind, the tilt angle of the PV modules 112, the number, size and weight of the PV modules 112 coupled to the torque tube 114, and the length of the torque tube 114, amongst other things.

When the force of the wind overcomes the maximum threshold level of the output of the electric motor 14, the electric motor 14 may act as a generator which converts kinetic energy from the back-drivable gear assembly 16 into electrical energy. The electrical energy produced can be dissipated in heat through a resistor network or used to load a battery or a capacitor which may be used to power the electric motor 14. For example, in forms where the power source 20 is a battery, the electrical energy produced by the electric motor 14 may be stored in the power source 20. Thus, the reversible tracker drive assembly 12 acts as an electro-mechanical clutch to allow some slippage by the torque tube in the direction of the external force. As such, conventional mechanical clutch mechanisms may not be necessary in the solar tracking system 110.

When the force of the wind for example overcomes the maximum threshold level of the output of the electric motor 14, the electric motor 14 may also act as a brake by providing resistance to rotation of the torque tube 114 in order to control the rotation speed of the torque tube 114, and in turn of the PV 112 modules coupled thereto, in a manner which avoids wind damage to the solar tracking system 110. Thus, the reversible tracker drive assembly 12 acts as an electro-mechanical damper to control a rate at which the torque tube 114 rotates in the direction applied by the external force.

In order to provide resistive braking control, the system 10 may include a resistive device such as resistor 21, which in the illustrated form is a component of the control module 18, although forms in which the resistor 21 is a standalone device are also possible. The resistor 21 is coupled to the electric motor 14. A chopper or a pulse width modulation (PWM) circuit 24 (a micro-processor with a PID) is a component of the control module 18 (although variations where the PWM circuit 24 is a standalone device are possible) and may monitor speed of the electric motor 14 when it acts as a generator. The control module 18 may also be configured to monitor and account for this speed during its control of the braking torque of the electric motor 14. Similar to the maximum threshold level of the output from the electric motor 14, the braking torque of the electric motor 14 may be dependent on the speed and/or direction of the wind, the tilt angle of the PV modules 112, the number, size and weight of the PV modules 112 coupled to the torque tube 114, and the length of the torque tube 114, amongst other things.

The control module 18 may include programmable software that enables the braking torque to be variable as a function of, for example, the tilt angle of the PV modules 112 amongst other things. By way of example, the braking torque may be increased when the angle of the PV modules 112 is about zero degrees, decreased when the tilt angle of the PV modules 112 is between zero and a stow position of the PV modules 112, and again increased when the PV modules 112 are nearing a stow position so the PV modules 112 and/or the torque tube 114 have a smooth arrival and interaction with any mechanical end stop which may be present in the solar tracking system 110. However, variations in the variability of the braking torque are possible and may depend on a number of factors, including changing wind speeds for example. It is also contemplated that the programmable software in the control module 18 may be updated remotely with software updates which may include changes to various operational aspects of the electric motor 14. Similarly, amongst other things, the programmable software may be readily updated or modified to alter the braking torque of the electric motor 14, as well as the resulting rotation speed to the torque tube 114, in order to change the speed (including variability of the same) at which the torque tube 114 moves toward a stow orientation.

In the solar tracking system 110 of FIG. 1, there is a single electric motor 14 and back-drivable gear assembly 16 coupled with the torque tube 114. In this arrangement, the solar tracking system 110 also includes additional components that are configured to control rotational speed of the torque tube 114 as the PV modules 112 near a stow position to compensate for galloping or flutter in the torque tube 114, the occurrence of which may become greater as the distance along the torque tube 114 from the electric motor 14 and the back-drivable gear assembly 16 increases. For example, there may be increased galloping or flutter in the torque tube 114 at or near the support structures 116a and 116e than there is at or near the support structures 116b and 116d. As illustrated in FIG. 1, the solar tracking system 110 includes a first damper 118 coupled with and extending between the torque tube 114 and the support structure 116a, and a second damper 120 coupled with and extending between the torque tube 114 and the support structure 116e. In some forms, the first damper 118 and the second damper 120 may be positioned near respective ends of the torque tube 114, and in the illustrated form the electric motor 14 and the back-drivable gear assembly 16 are generally positioned in the middle of the torque tube 114, although variations are possible. The first damper 118 and the second damper 120 may be configured to assist in a smooth arrival and interaction of the PV modules 112 and/or the torque tube 114 with any mechanical end stop which may be present in the solar tracking system 110.

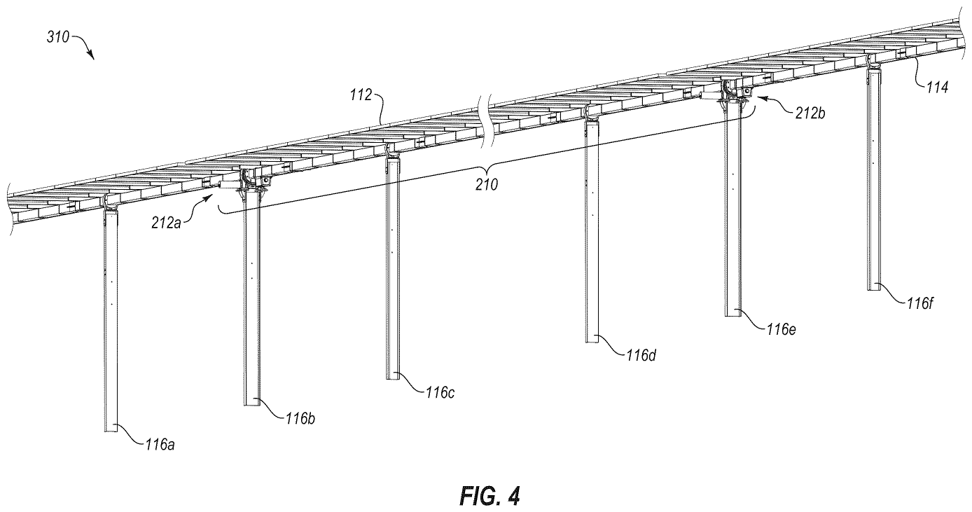

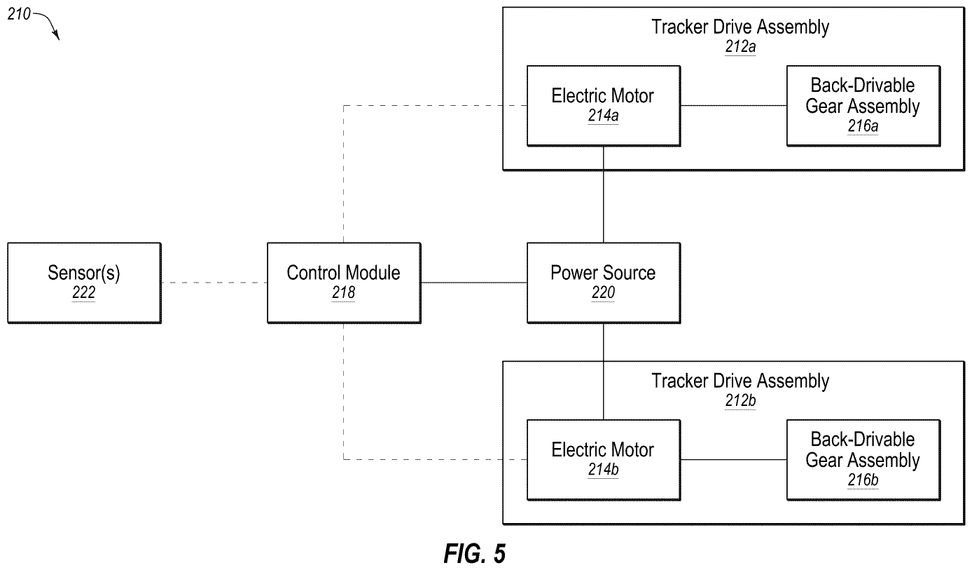

Embodiments are also possible and contemplated which omit one or more of these additional components that are configured to compensate for galloping of the torque tube 114. For example, and with reference to FIGS. 4 and 5 where like numerals refer to like features previously described, a system 210 that controls or regulates rotation of the torque tube 114 in a solar panel tracking system 310 includes a first reversible tracker drive assembly 212a and a second reversible tracker drive assembly 212b. The first reversible tracker drive assembly 212a of the system 210 includes a first electric motor 214a and a first back-drivable gear assembly 216a, and the second reversible tracker drive assembly 212b of the system 210 includes a second electric motor 214b and a second back-drivable gear assembly 216b. The system 210 further includes a control module 218, a power source 220 and a number of sensors 222. In the illustrated form, a single control module 218 is in communication with and configured to control various operational aspects of the electric motor 214a and the electric motor 214b. However, forms in which the system 210 includes multiple control modules each in communication with and configured to control various operational aspects of a respective one of the electric motor 214a and the electric motor 214b are also possible. Similarly, in these forms the system 210 may also include a respective sensor 222 or set of sensors 222 in communication with each of the control modules present, although the sensors 222 may collectively communicate with the control modules present. In the illustrated form, the electric motor 214a and the electric motor 214b share the power source 220. However, forms in which each of the electric motor 214a and the electric motor 214b has its own power source are possible.

The first electric motor 214a, the first back-drivable gear assembly 216a, the second electric motor 214b and the second back-drivable gear assembly 216b may be the same as or substantially similar to the electric motor 14 and the back-drivable gear assembly 16 as described herein above. In one form, it is contemplated that the first electric motor 214a and the second electric motor 214b may be smaller than the electric motor 14. The control module 218 may be the same as or substantially similar to the control module 18 as described herein above, provided that the control module 218 is configured to control operational aspects of both the first electric motor 214a and the second electric motor 214b. Further, the power source 220 and the sensor(s) 222 may be the same as or substantially to the power source 20 and the sensor(s) 22 described herein above.

The first electric motor 214a and the first back-drivable gear assembly 216a may be positioned relative to the torque tube 114, and engaged with the torque tube 114, at a location which is typically spaced about one quarter to one third of the total length of the torque tube 114 from a first end of the torque tube 114, and the second electric motor 214b and the second back-drivable gear assembly 216b may be positioned relative to the torque tube 114, and engaged with the torque tube 114, at a location which is typically spaced about one quarter to one third of the total length of the torque tube 114 from a second end of the torque tube 114. In alternative embodiments, the first electric motor 214a and the first back-drivable gear assembly 216a may be positioned on the torque tube 114 at a specified distance from the second electric motor 214b and the second back-drivable gear assembly 216b. In some forms this distance may be between about 60 and about 100 meters. For example, the first electric motor 214 a and the first back-drivable gear assembly 216a may be separated from the second electric motor 214b and the second back-drivable gear assembly 216 b by a distance of about 80 meters. In this configuration, the system 210 may provide adequate braking and rotational control of the torque tube 114, and control galloping of the torque tube 114, such that additional components (like springs and dampers) may be omitted, although inclusion of one or both of springs and dampers is also possible.

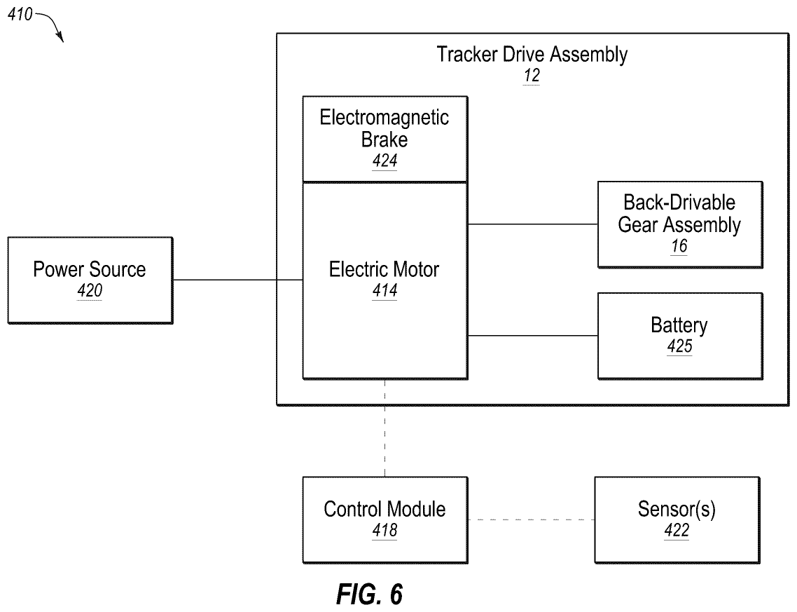

FIG. 6 schematically illustrates an alternative system 410 for controlling rotation of a torque tube 114 in a solar tracking system, such as the system 110 or the system 310. The system 410 includes a reversible tracker drive assembly 412 which includes an electric motor 414 and a back-drivable gear assembly 416. The system 410 also includes a control module 418. The electric motor 414 and the back-drivable gear assembly 416 may be configured similarly to the electric motor 14 and the back-drivable gear assembly 16 as described above. The system 410 also includes a power source 420 and a number of sensor(s) 422, and these components may be the same as or substantially to the power source 20 and the sensor(s) 22 described herein above. The reversible tracker drive assembly 412 also includes an electromagnetic brake 424, which is coupled with the electric motor 414. The electromagnetic brake 424 may normally be in a closed configuration which prevents operation of the electric motor 414. When rotation of the torque tube 114 is desired, the control module 418 is configured to power the electromagnetic brake 424 to an open position, and to active the electric motor 414 to rotate the torque tube 114. Once the torque tube 114 is in its desired position, the electric motor 414 is deactivated and power is terminated to the electromagnetic brake 424, returning it to its normally closed configuration, preventing further operation of the electric motor 414, and maintaining the torque tube 114 in its desired position.

The control module 418 is further configured to power the electromagnetic brake 424 to an open position if the force of wind on PV modules and/or other components of a solar tracking system reaches a level where damage to the solar tracking system may occur. When the electromagnetic brake 424 is powered in this manner, the force of the wind may result in back-driving of the electric motor 414 as rotational energy of the torque tube 114 is translated to the electric motor 414 by the back-drivable gear assembly 416. The electric motor 414 may then provide a braking torque to control or limit the rotational speed of the torque tube 114, which may be variable depending on the tilt angle of PV modules, amongst other things. In one form, the control module 418 is configured to measure current in a resistor network and to power the electromagnetic brake 424 when the measured current satisfies a predetermined value which is indicative that the force of wind on the PV modules and/or other components of the solar tracking system is at or near a level where damage to the solar tracking system may occur. Additionally or alternatively, one or more of the sensors 422 may provide wind data, such as speed and direction, to the control module 418 and this data may be accounted for by the control module 418 when it determines to release the electromagnetic brake 424 and to provide a braking torque with the electric motor 414 to control or limit the rotational speed of the torque tube 114. For example, it may be determined by the control module 418 to release the electromagnetic brake 424 and to provide a braking torque with the electric motor 414 to control or limit the rotational speed of the torque tube 114 if the wind data indicates that wind speed exceeds a predetermined value.

In addition, in some embodiments, one or more of the systems 110, 210, and 410 may be configured to detect galloping/oscillation of the torque tube 114 due to wind or other forces on the PV modules and/or torque tube 114. Galloping/oscillation of the torque tube 114 may increase in frequency or magnitude to a level that causes damage or failure to one or components of the system 110, 210 or 410, so in response to the system 110, 210 or 410 detecting galloping/oscillation (or a level of magnitude, frequency or duration of galloping/oscillation for example) of the torque tube 114, the system 110, 210 or 410 may be further configured to move the PV modules to a position where the galloping/oscillation is reduced or eliminated before the galloping/oscillation causes damage to the system 110, 210 or 410. In some aspects for example, the PV modules could be moved to a stow position to stop the galloping/oscillation before it causes damage to the system 110, 210 or 410.

In one form for example, the system 110, 210 or 410 may include one or more sensors (such as one or more of the sensors 22, 222, or 422) configured to detect current drawn by the electric motor 14, 214a/214b or 414 during normal operation/rotation of the torque tube 114 or when providing a resistive braking force to the torque tube 114, including current associated with the motor 14, 214a/214b or 414 resisting external forces acting on the torque tube 114. Variations or oscillations in this resistive current may be indicative of corresponding low-frequency resistance oscillations imparted to the torque tube 114. When the control module 18, 218, or 418 detects a pattern of low-frequency resistance oscillation characteristic of galloping, the control module 18, 218 or 418 may be further configured to activate the electric motor 14, 214a/214b or 414 to rotate the torque tube 114 to position the PV modules in a manner that reduces or eliminates the galloping/oscillation. In this manner, upon detection of galloping conditions, based either on the monitored current used to resist movement of the torque tube 114 or on overall current variations, the electric motor 14, 214a/214b, or 414 may actively rotate the torque tube 114 to escape the oscillatory motion and position the PV modules to avoid the same, thereby mitigating potential structural or operational impacts associated with continued oscillation. In some forms for example, the torque tube 114 may be rotated to position the PV modules in a stow position,

Additionally or alternatively, one or more of the sensors 22, 222 and 422 of the systems 110, 210 and 410, respectively, may be configured to detect motion or movement of the torque tube 114 and/or the PV modules coupled thereto. The control module 18, 218, or 418 may be further configured to determine when motion or movement detected by these sensors may be indicative of oscillations characteristic of galloping of the torque tube 114. When such motion or movement is detected, the control module 18, 218 or 418 may be further configured to activate the electric motor 14, 214a/214b or 414 to rotate the torque tube 114 to position the PV modules in a manner that reduces or eliminates the galloping/oscillation. In some forms for example, the torque tube 114 may be rotated toward a stable stow position of the PV modules.

While rotation of the torque tube 114 to place the PV modules in a stow position or to otherwise escape galloping/oscillation in response to detecting variations or oscillations in resistive current which may be indicative of corresponding low-frequency resistance oscillations imparted to the torque tube 114, or in response to a determination that detected motion or movement may be indicative of oscillations characteristic of galloping of the torque tube 114, is described in the context of the systems 110, 210 and 410 which include the back-drivable gear assembly 16, 216a/216b or 416, it is contemplated that rotation the torque tube 114 to place the PV modules in a stow position in response to the relevant current and/or motion detection may be performed in connection with systems where the back-drivable gear assembly is not present.

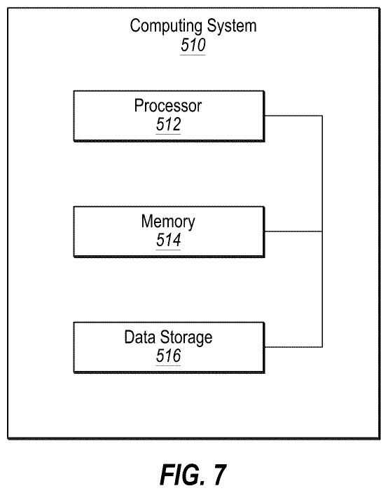

FIG. 7 illustrates a block diagram of an example computing system 510. The computing system 510 may be configured according to at least one embodiment of the present disclosure and may be an example of computing systems that may include or be part of one or more elements of the system 10, 210 and/or 410. For example, the system 10, 210 and/or 410 may include one or more computing systems 510. The computing system 510 includes a processor 512, a memory 514, and a data storage 516. The processor 512, the memory 514, and the data storage 516 may be communicatively coupled.

In general, the processor 512 may include any suitable special-purpose or general-purpose computer, computing entity, or processing device including various computer hardware or software modules and may be configured to execute instructions stored on any applicable computer-readable storage media. For example, the processor 512 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 7, the processor 512 may include any number of processors configured to, individually or collectively, perform or direct performance of any number of operations described in the present disclosure. Additionally, one or more of the processors may be present on one or more different electronic devices, such as different servers.

In some embodiments, the processor 512 may be configured to interpret and/or execute program instructions and/or process data stored in the memory 514, the data storage 516, or the memory 514 and the data storage 516. In some embodiments, the processor 512 may fetch program instructions from the data storage 516 and load the program instructions in the memory 514. After the program instructions are loaded into memory 514, the processor 512 may execute the program instructions.

The memory 514 and the data storage 516 may include computer-readable storage media for carrying or having computer-executable instructions or data structures stored thereon. Such computer-readable storage media may include any available media that may be accessed by a general-purpose or special-purpose computer, such as the processor 512. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store program code in the form of computer-executable instructions or data structures and which may be accessed by a general-purpose or special-purpose computer. In these and other embodiments, the term “non-transitory” as explained herein should be construed to exclude only those types of transitory media that were found to fall outside the scope of patentable subject matter in the Federal Circuit decision of In re Nuijten, 500F. 3 d 1346 (Fed. Cir. 2007). Combinations of the above may also be included within the scope of computer-readable media.

Modifications, additions, or omissions may be made to the computing system 510 without departing from the scope of the present disclosure. For example, in some embodiments, the computing system 510 may include any number of other components that may not be explicitly illustrated or described.

For instance, in some embodiments, the computing system 510 may include a communication unit that includes any component, device, system, or combination thereof that is configured to transmit or receive information over a network. In some embodiments, the communication unit may communicate with other devices at other locations, the same location, or even other components within the same system. For example, the communication unit may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit may permit data to be exchanged with a network and/or any other devices or systems described in the present disclosure. For example, the communication unit may allow the system 510 to communicate with other systems, such as computing devices and/or other networks.

Additionally or alternatively, the computing system 510 may include one or more user interfaces in some embodiments. The user interfaces may include any system or device to allow a user to interface with the system 510. For example, the interfaces may include a mouse, a track pad, a keyboard, and/or a touchscreen, among other devices or systems. The interfaces may also include a graphical user interface that may be presented on a display that may be included with the computing system 510. The display may be configured as one or more displays, like an LCD, LED, or other type of display. The display may be configured to present content such as video, text, user interfaces, and other data as directed by the processor.

As indicated above, the embodiments described in the present disclosure may include the use of a special purpose or general purpose computer (e.g., the processor 512 of FIG. 7) including various computer hardware or software modules, as discussed in greater detail below. Further, as indicated above, embodiments described in the present disclosure may be implemented using computer-readable media (e.g., the memory 514 or data storage 516 of FIG. 7) for carrying or having computer-executable instructions or data structures stored thereon.

In some embodiments, the different components, modules, engines, and services described herein may be implemented as objects or processes that execute on a computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

1. A system, comprising:
a reversible tracker drive assembly including:
an electric motor; and
a back-drivable gear assembly structured to translate an output generated by the electric motor to a rotational input on a torque tube and to translate an output from the torque tube to a back force on the electric motor; and
a control module configured for limiting the output from the electric motor to a maximum threshold level and, in response to a back force on the electric motor exceeding the maximum threshold level of the output generated by the electric motor, providing a resistive braking force with the electric motor to control rotational speed of the torque tube.

2. The system of claim 1, wherein the back-drivable gear assembly includes a back-drivable high reduction gearbox and a back-drivable slew drive.

3. The system of claim 2, wherein the back-drivable high reduction gearbox is configured for coupling with the electric motor and the back-drivable slew drive is configured for coupling with the torque tube.

4. The system of claim 1, wherein the control module is further configured to provide varying degrees of the resistive braking force.

5. The system of claim 1, further comprising at least one sensor configured to provide wind data to the control module.

6. The system of claim 1, further comprising a second electric motor and a second back-drivable gear assembly.

7. The system of claim 1, further comprising at least one of a battery, a capacitor and a resistor configured to receive electrical energy converted from kinetic energy by the electric motor.

8. The system of claim 1, wherein the control module includes a number of resistors configured to control the resistive braking.

9. The system of claim 1, wherein the control module is further configured for increasing the output from the electric motor to the maximum threshold level to counteract back force on the electric motor.

10. The system of claim 1, further comprising one more current sensors configured to detect current drawn by the electric motor, and wherein the control module is further configured for rotating the torque tube with the electric motor to a position reducing or eliminating galloping of the torque tube in response to current detected by the one or more current sensors being indicative of galloping of the torque tube.

11. A system, comprising:
a reversible tracker drive assembly including:
an electric motor;
a back-drivable gear assembly structured to translate an output generated by the electric motor to a rotational input on a torque tube and to translate an output from the torque tube to a back force on the electric motor;
an electromagnetic brake having a normally closed configuration for preventing rotation of the torque tube; and
a control module configured for powering the electromagnetic brake to an open configuration and activating the electric motor when the electromagnetic brake is in the open configuration.

12. The system of claim 11, wherein the control module is further configured for providing a resistive braking force with the electric motor to control rotational speed of the torque tube when the electromagnetic brake is in the open configuration and a back force on the electric motor exceeds the output generated by the electric motor.

13. The system of claim 12, further comprising one more current sensors configured to detect current drawn by the electric motor, and wherein the control module is further configured for rotating the torque tube with the electric motor to a position reducing or eliminating galloping of the torque tube in response to current detected by the one or more current sensors being indicative of galloping of the torque tube.

14. A method for controlling rotation of a torque tube in a solar tracking system, comprising:
operating an electric motor at a maximum threshold level to rotate the torque tube; and
in response to a back force on the electric motor transmitted by a back-drivable gear assembly from a rotation force on the torque tube exceeding the maximum threshold level, providing a resistive braking force with the electric motor to control rotational speed of the torque tube.

15. The method of claim 14, further comprising varying a degree of the resistive braking dependent on an orientation of the torque tube.

16. The method of claim 15, further comprising increasing the resistive braking when the orientation of the torque tube approaches a stow position for a number of photovoltaic modules mounted thereon.

17. The method of claim 14, further comprising detecting current drawn by the electric motor and rotating the torque tube with the electric motor to position reducing or eliminating galloping of the torque tube in response to current detected by the one or more current sensors being indicative of galloping of the torque tube.

18. A system, comprising:
an electric motor configured to impart a rotational force to a torque tube;
one or more current sensors configured to detect current drawn by the electric motor; and
a control module configured for rotating the torque tube with the electric motor to a position reducing or eliminating galloping of the torque tube in response to current detected by the one or more current sensors being indicative of galloping of the torque tube.

19. The system of claim 18, further comprising a back-drivable gear assembly structured to translate an output generated by the electric motor to a rotational input on a torque tube and to translate an output from the torque tube to a back force on the electric motor.

20. The system of claim 19, further comprising one or more motion sensors configured to detect movement of the torque tube, and wherein the control module is further configured for rotating the torque tube with the electric motor to a position reducing or eliminating galloping of the torque tube in response to movement of the torque tube detected by the one or more motion sensors being indicative of galloping of the torque tube.
